(19) United States
(12) Patent Application Publication
(10) Pub. No.: US 2026/0234023 A1
(43) Pub. Date: Aug. 13, 2026

(54) RECOVERY OF PHOSPHORUS COMPOUNDS AND IRON COMPOUNDS FROM IRON PHOSPHATE-CONTAINING MATERIALS

(71) Applicant: LANXESS Deutschland GmbH, Cologne (DE)

(72) Inventor: Matthias Boll, Cologne (DE)

(73) Assignee: LANXESS Deutschland GmbH, Cologne (DE)

(21) Appl. No.: 19/151,891

(22) PCT Filed: Feb. 7, 2024
(86) PCT No.: PCT/EP2024/053037

§ 371 Date: Jul. 29, 2025

(30) Foreign Application Priority Data
Feb. 14, 2023 (EP) 23156584.7
Sep. 22, 2023 (EP) 23199051.6

(51) Int. Cl. C01G 49/10; C01B 25/10; C22B 1/08; H01M 10/54

(52) U.S. Cl. CPC C01G 49/10; C01B 25/10; C22B 1/08; H01M 10/54

(57) ABSTRACT

The invention relates to a method of obtaining phosphorus compounds and iron compounds from iron phosphate-containing materials, characterized in that
i) an iron phosphate-containing material is reacted in the presence of a carbon source with chlorine gas at a temperature of 300 to 900° C. and
ii) the chlorine-phosphorus compounds formed, especially phosphorus oxychloride and any phosphorus trichloride, and iron chloride are led off in the offgas stream, and
iii) the iron chloride and
iv) the chlorine-phosphorus compounds are separated from the offgas stream.

The invention relates to a method of recovering phosphorus compounds and iron compounds from iron phosphate-containing materials.

Lithium iron phosphate (LFP) and lithium iron manganese phosphate (LFMP) and the modifications thereof that may have been doped with further elements, especially metals, are known as cathode materials—also referred to as cathode active materials (CAM)—for batteries and are preferably used in electrical vehicles and stationary batteries.

Since the lithium ion battery market is growing significantly and every car battery contains between 100 kg and 200 kg of CAM, the mass of valuable constituents such as lithium, phosphorus and iron and other ingredients is also large, which means that the recycling of such used batteries for recovery of these raw materials is very important. Particular significance attaches here to lithium, an element that has been the subject of ever greater demand in recent years. Likewise important is the phosphorus present, which is regarded as a critical raw material in many regions of the world.

The recycling operation typically involves breaking up the battery cells mechanically if possible and comminuting the remainder comprising the cathode material and anode material, any binders and further constituents to a mass, which is black because of the dark-coloured LFP and the carbonaceous, especially graphite-containing, anode material and is therefore called “black mass”. Black mass, as a result of technically incomplete separation, may also contain residues of other battery constituents, for example metals.

The literature proposes various approaches for recycling of the LFP-containing black mass or of the pure, spent LFP. For example, the spent LFP-containing material, in Qifang Sun et al, Journal of Alloys and Compounds 818(2020 ) 153292, is subjected to thermal treatment to give a low-Li material which is to be converted back to LFP by appropriate addition of lithium carbonate and a carbon source. However, the resulting low-Li end product is very indeterminate, which results in a correspondingly indeterminate LFP. The same also applies to the process according to Lingyu Guan et al. in Renewable Energy 175(2021 ) 559-567, in which the LFP freed in the recycling, together with specific Li, Fe and P reactants and a carbon source, leads to a mixture of old and new LFP, which is likewise difficult to specify.

Other processes oxidize the iron(II) present in the LFP in different ways, for instance with hypochlorite or peroxodisulfate or H₂O₂ in the presence of acids, to iron(III) and extract the lithium released from the crystal form. The latter is described, for example, in Yang, Yongxia; Meng, Xiangqi; Cao, Hongbin; Lin, Xiao; Liu, Chenming; Sun, Yong; Zhang, Yi; Sun, Zhi, Green Chemistry 20/13 (2018 ) 3121-3133. But the typically contaminated iron phosphate (FP) which is likewise obtained can be used only to a limited degree for production of LFP because of impurities present.

The exclusive recovery of the lithium in the abovementioned processes means that only a small proportion by mass of the LFP used is sent to a reuse, which means that the question of LFP and LFMP recycling can be considered to be unanswered.

A common factor in the processes in which lithium is separated from LFP and/or LFMP or a black mass comprising these is that what remains is a proportionally large residue of iron phosphate-containing material of greater or lesser purity, which has to be worked up further.

It was therefore an object of the present invention to find a method of obtaining phosphorus compounds and iron compounds from iron phosphate-containing materials that does not create any large waste streams and hence enables reutilization of iron phosphate-containing material, regardless of its origin.

The invention therefore relates to a method of obtaining phosphorus compounds and iron compounds from iron phosphate-containing materials, characterized in that
i) an iron phosphate-containing material is reacted in the presence of a carbon source with chlorine gas (Cl₂) at a temperature of 300 to 900° C. and
ii) the chlorine-phosphorus compounds formed, especially phosphorus oxychloride and any phosphorus trichloride, and iron chloride are led off in the offgas stream, and
iii) the iron chloride, preferably by resublimation, and
iv) the chlorine-phosphorus compounds, especially phosphorus oxychloride and any phosphorus trichloride, preferably by condensation, are separated from the offgas stream.

The method according to the invention is preferably suitable for obtaining chlorine-phosphorus compounds, especially phosphorus oxychloride and any phosphorus trichloride and chlorine-iron compounds, especially iron(III) chloride.

### Iron Phosphate and Iron Phosphate-Containing Material

Iron phosphate in the context of this invention is especially understood to mean a compound consisting to an extent of at least 97% by weight, more preferably to an extent of at least 99.5% by weight, of the elements iron, phosphorus, manganese, aluminium, nickel, titanium and oxygen, especially of the elements iron, phosphorus, manganese and oxygen, and more preferably of the elements iron, phosphorus and oxygen. In the crystal structure of iron phosphate, in the context of this invention, it is also possible for some iron lattice sites to be occupied by one or more of the metal ions named above. The iron phosphates may also be in hydrate form. The iron phosphate may preferably be iron(III) phosphate FePO₄, especially FePO₄:2H₂O, iron(II) phosphate, especially Fe₃(PO₄)₂·8H₂O, and iron(III) pyrophosphate, especially Fe₄(P₂O₇)₃, and compounds of the general formula FeₓMe_{y}PO₄ where Me means manganese, aluminium, nickel and titanium, especially manganese, where x is between 0<x≤3 and y is between 0≤y<2.5.

More preferably, the iron phosphate may be iron(III) phosphate FePO₄, especially FePO₄·2H₂O, iron(II) phosphate, especially Fe₃(PO₄)₂·8H₂O, and iron(III) pyrophosphate, especially Fe₄(P₂O₇)₃.

The iron phosphate-containing material used for the method according to the invention is especially a material containing a proportion of 5% to 100% by weight, preferably 40% to 99% by weight, especially 50% to 99% by weight, more preferably from 70% to 90% by weight, of iron phosphate.

Preference is given to using a material containing a proportion of 5% to 100% by weight, preferably 40% to 99% by weight, especially 50% to 99% by weight, more preferably from 70% to 99% by weight, of at least one iron phosphate from the group consisting of iron(III) phosphate FePO₄, iron(II) phosphate, especially Fe₃(PO₄)₂·8H₂O, FePO₄·2H₂O and iron(III) pyrophosphate, especially Fe₄(P₂O₇)₃or FeₓMe_{y}PO₄, where Me means manganese, aluminium, nickel and titanium, especially manganese, and x is between 0<x≤3 and y is between 0≤y<2.5.

The proportion of LFP and LFMP in the iron phosphate-containing material is preferably less than 1% by weight.

The description of the composition of the material used is preferably also possible via the determination of the proportion by weight of particular elements in the iron phosphate-containing material, based in each case on the amount of iron phosphate-containing material, wherein the material used preferably contains:
1% to 38% by weight of Fe,
1% to 30% by weight of P,
0% to 35% by weight of Mn,
0% to 35% by weight of Al,
0% to 35% by weight of Ni,
0% to 35% by weight of Ti,
0% to 55% by weight, preferably 0% to 40% by weight, especially 1% to 30% by weight, of carbon.

These amounts may come firstly from the iron phosphate itself, but also from the remaining constituents of the material used, for example from residues of metallic constituents or from parts of the anode as may still be present in the black mass even after Li has been leached out. It is also possible for further doping elements to be present. The elemental contents are preferably determined via the conventional methods of elemental analysis.

The iron phosphate-containing material used preferably has a water content of less than 1% by weight.

The iron phosphate-containing material used is preferably obtained as the residue from a reaction of LFP and/or LFMP or a black mass comprising them, preferably with H₂O₂ in the presence of an acid, preferably a C₁-C₁₀ carboxylic acid, especially aliphatic carboxylic acid, more preferably acetic acid, whereby the LFP- and/or LFMP-containing material has been largely freed of lithium and preferably has an Li content of less than 2% by weight, especially less than 1% by weight, based on the material. Such a reaction is preferably effected at temperatures of 20 to 90° C.

The residue is preferably recovered over several hours to days by continuous extraction of the iron phosphate-containing material.

It is also possible for metals to be present in the material used, preferably from 0% to 15% by weight, preferably 0% to 5% by weight, especially Al, Cu, Co and Ni.

It is preferable that the iron phosphate-containing material used contains preferably less than 10% by weight, especially less than 1% by weight, more preferably less than 0.1% by weight, of polymer particles, especially plastic.

It is also preferable when the iron phosphate-containing material used contains less than 5% by weight of PVDF (polyvinylidene fluoride) and/or other binders, for example, carboxymethylcellulose and/or alginates. The content of all binders is preferably less than 5% by weight.

The VOC content of the iron phosphate-containing material used is preferably less than 1% by weight, especially less than 0.1% by weight, more preferably less than 0.01% by weight. VOCs (volatile organic compounds) are preferably understood to mean organic compounds having boiling points in the range from 50 to 260° C., at a standard pressure of 101.3 kPa.

The iron phosphate-containing material used preferably has an average particle size of 0.1 μm to 10 mm. The particle size, depending on the dimensions, can be determined easily via sieving or, for smaller particles, via the method of laser diffraction or laser scattering; the best method to be used in the particular case is known to the person skilled in the art.

If the iron phosphate-containing material used has a binder content of greater than 1% by weight, based on the material, leaching is preferably effected by a treatment with organic solvent, especially acetone, ethyl acetate, methyl ethyl ketone, tetrahydrofuran (THF), ethyl acetoacetate, acetylacetone, dioxane and/or acetic anhydride and mixtures thereof, in order to reduce the content to less than 0.1% by weight.

If the iron phosphate-containing material contains a polymer content, especially plastic, of greater than 1% by weight, it is advantageous first to subject the material to a thermal treatment at a temperature of 300 to 600° C., preferably under inert gas, in order to reduce the polymer content to less than 0.1% by weight. A possible binder content of greater than 1% by weight, in addition to leaching with organic solvents, can alternatively or additionally likewise be reduced to less than 0.1% by weight by a thermal treatment at a temperature of 300 to 700° C., preferably under inert gas.

### Carbon Source

Carbon sources may in principle include any modification of carbon, such as graphite, soot, charcoal, coke, activated carbon, but also carbonaceous gases such as carbon monoxide, methane or phosgene, but also liquid materials such as polyethylene glycol or various oils or solid materials such as biowastes or sewage sludge. Sewage sludge is particularly preferred.

This preferably contains carbon in a proportion of at least 5% by weight, preferably of 20% to 50% by weight, based on the dry mass.

In the context of the present invention, the term “sewage sludge” refers to any suspension of finely divided particles of a solid substrate in a liquid. The sewage sludge preferably contains a carbon content, expressed in % by weight of elemental carbon, of at least 5% by weight of carbon. In a preferred embodiment, the liquid in which the particles are suspended is wastewater as defined herein. The term “wastewater” is understood to mean all aqueous and/or organic liquids or mixtures thereof that do not have drinking water quality within the scope of drinking water standards.

In a particular embodiment, the sewage sludge takes the form of primary sludge, raw sludge, excess sludge, or of treated and/or stabilized sewage sludge (aerobic/anaerobic).

The term “biowastes” is understood to mean all organic wastes of animal or plant origin that are obtained in a household or factory and can be degraded by microorganisms, soil-dwelling organisms or enzymes. Examples of these can include straw, sawdust, waxes, fats and bird droppings.

The carbon source may be solid, liquid or gaseous. preference is given to the use of a solid carbon source.

If the carbon content in the carbon source should be less than 70% by weight, pyrolysis is preferably conducted before the reaction with chlorine gas. This is preferably conducted under inert gas such as nitrogen at temperatures of 250 to 800° C., preferably at 350 to 550° C., until the amount of gas formation of volatile components is less than 1 l/1 kg of carbon source used/hour.

The carbon source used is more preferably sewage sludge.

The chloride content in the carbon source, especially based on the dry weight thereof, is preferably less than 1% by weight.

If the iron phosphate-containing material used, for example because it originates as the residue from the depletion of Li from LFP and/or LFMP or in particular from a black mass comprising these, already contains at least a portion of the carbon source, it especially contains preferably 1% to 55% by weight, preferably 1% to 40% by weight, especially 1% to 30% by weight, of carbon, especially graphite and/or soot.

Preferably, the sum total of iron phosphate and carbon, based on the iron phosphate-containing material, is more than 70% by weight, preferably more than 80% by weight, more preferably more than 90% by weight.

Preferably, the iron phosphate-containing material has a molar carbon-to-phosphorus ratio of not less than 1.5, preferably of 1.5 to 20, more preferably of 1.5 to 10, especially 1.5 to 5, most preferably of 1.5 to 4.

If the material used contains less than 1.5 mol of carbon per 1 mol of phosphorus, based on the iron phosphate present in the material, a sufficient amount of carbon is preferably added to the material before the reaction that the desired ratio is attained.

### Reactor

The material to be used in the method according to the invention is preferably introduced into a reactor that has preferably been provided with a layer which is resistant under the reaction conditions to be established. Preferred reactor materials are nickel- or graphite-coated reactors or reactors made of quartz. Reactors used may be tubular reactors such as rotary tube reactors or other reactors. Particular preference is given to reactors that permit movement of the material during the reaction, in order to permit very effective contact between material and chlorine gas. Preference is given to fluidized bed apparatuses and rotary tube reactors, or a reaction in an extruder apparatus with screw propulsion.

In the case of a tubular reactor, the reactor length is preferably 0.2 to 40 m. The dwell time in the reactor during the reaction is generally guided by temperature and the possibility of contact of material with chlorine gas. The dwell time in the reactor may extend, for example, from one minute to 10 hours. The method according to the invention may be conducted batchwise or continuously.

### METHOD

### Step i)

The reaction is preferably effected with exclusion of air. Any air present in the reactor is displaced at the start of the reaction, preferably by an inert gas, for example nitrogen. The reaction with chlorine gas is effected at a temperature of 300 to 900° C., especially at 350 to 800° C. If the method is conducted at a temperature of 300 to 320° C., it is advantageous not to completely drive out iron chloride that has escaped from the reactor by a subsequent increase in temperature to 350 to 400° C. The temperature is preferably increased after the content of phosphorus compounds in the offgas, measured with the aid of a gas phase IR spectrometer correspondingly calibrated in per cent by weight, is less than 0.1% by weight, especially less than 0.01% by weight.

The chlorine gas can be contacted with the material in various ways. The chlorine is preferably passed over or through the material, while the material is preferably kept in motion during the reaction for effective reaction. This can be effected in a rotary tube furnace or in a paddle dryer in which the material is kept in motion. The chlorine gas can also be passed through the material, which can be achieved, for example, in a fluidized bed or fixed bed. Optionally, for this purpose, the material may have been subjected to shaping beforehand, for example compaction or pelletization.

There is preferably an outlet for the offgas stream in the reactor. The offgas stream includes the gaseous reaction products, volatile constituents of the material and excess chlorine gas, which can be led off together from the reaction space.

The reaction has preferably ended when the proportion of phosphorus compounds, preferably measured with the aid of a gas phase IR spectrometer correspondingly calibrated in per cent by weight, is less than 0.1% by weight, especially less than 0.01% by weight.

### Step ii)

The offgas stream also includes, as well as the chlorine-phosphorus compounds, especially phosphorus oxychloride and any phosphorus trichloride, also gaseous iron(III) chloride, and also any AlCl₃ if aluminium is present in the material used.

### Step iii)

At a reaction temperature of 300 to 320° C., the proportion of iron chloride in the offgas stream is still generally comparatively small and increases only after an increase in temperature to 350 to 600° C. Iron(III) chloride and also AlCl₃, if aluminium is present in the material used, can be separated out of the offgas stream, preferably by resublimation on surfaces cooled to different degrees, and separated from one another. If the iron chloride is present in the offgas stream together with AlCl₃, the respective chlorides, because of sufficiently different boiling points, can be resublimed, even in fractionated form, on different surfaces with different temperatures and hence separated very cleanly.

Preferred precipitation temperatures for FeCl₃ are not more than 307° C., especially 150 to 300° C., and, for AlCl₃, not more than 150° C., especially 110 to 149° C.

The iron recovered after the method according to the invention in the form of iron(III) chloride may optionally be separated from adhering chlorine-phosphorus compounds. This can be accomplished by treatment with acid, for instance sulfuric acid, preferably concentrated sulfuric acid, or by a thermal drying step or in another manner known to the person skilled in the art. Preferably, the iron chloride isolated in step iii) is reacted with sulfuric acid, with release and then optionally condensation of any chlorine-phosphorus compounds present.

Conversion is then possible to the desired raw material form of iron, for example for the production of LFP and/or LFMP. Examples here include iron sulfate, iron nitrate, iron phosphate, or the widest variety of different forms of iron oxide.

Alternatively, the iron chloride, even without having been separated out by resublimation, can be introduced directly as a gas stream into an aqueous medium containing sulfuric acid or nitric acid and hence made to form corresponding iron(III) sulfates or nitrates. If necessary, a suitable reducing agent is also used in the reaction in order to arrive at an iron(II) sulfate, iron(II) nitrate or iron(II) phosphate.

However, preference is given to separating iron chloride from the offgas stream by resublimation.

### Step iv)

In the method according to the invention, the chlorine-phosphorus compounds, preferably the phosphorus oxychloride and any phosphorus trichloride likewise formed, may preferably be removed from the offgas stream by means of a condenser, and any excess chlorine gas may be recycled.

Phosphorus oxychloride, which is gaseous at the reaction temperature, and any phosphorus trichloride likewise formed are separated from the offgas stream by means of a condenser. What is generally formed is a mixture of phosphorus oxychloride and phosphorus trichloride, which can be separated further by distillation with regard to its components. As a result, the can be obtained in very pure

The method according to the invention is preferably characterized in that the offgas stream led off from step ii) contains phosphorus trichloride, and this, in the form of phosphorus trichloride-containing chlorine-phosphorus compounds from step iv), or after separation therefrom, is reacted with chlorine gas at a temperature of 20 to 160° C. to give phosphorus pentachloride.

Preference is given here to a molar chlorine/phosphorus trichloride ratio of 1:20.

Preference is given to the method according to the invention for recovery of phosphorus compounds in the form of chlorine-phosphorus compounds, especially in the form of a mixture of phosphorus oxychloride and phosphorus trichloride.

Phosphorus oxychloride can be converted via a hydrolysis step to polyphosphoric acid or phosphoric acid, from which the salts thereof can be produced by neutralization if required, and these can optionally then be used again for production of LFP and/or LFMP.

Phosphorus oxychloride and phosphorus trichloride are typically obtained in the offgas stream in a weight ratio of 10:1 to 1:10.

The chlorine-phosphorus compounds from the method according to the invention can be run in favour of phosphorus trichloride and hence of the preferred reactant for phosphorus pentachloride formation in that the method is preferably conducted above 500° C. It is likewise preferable to conduct the method at a carbon/phosphorus ratio of greater than 3 mol/mol. In this way, the ratio of phosphorus trichloride/phosphorus oxychloride of greater than 1 can be achieved.

If the method according to the invention is conducted without a stoichiometric chlorine excess and hence little to no chlorine is present in the offgas stream, the offgas stream containing the chlorine-phosphorus compounds, especially phosphorus oxychloride and any phosphorus trichloride, once it has been freed of iron chloride, can also preferably be introduced into an aqueous solution in order to obtain the corresponding acids of phosphorus, such as phosphoric esters and phosphonic acids, from which any other phosphorus derivatives can then be produced.

After the method according to the invention has ended, all constituents of the material used that are nonvolatile under reaction conditions or nonvolatile reaction products thereof, especially in the form of chlorides,, are present in the residue, as are unconverted iron phosphate-containing material and unconverted carbon. For further workup of the residue and recovery of materials of value, the residue can be partly dissolved in water, preferably at a temperature of 10 to 40° C., and separated from insoluble constituents.

One particular insoluble residue from the method according to the invention is graphite or other carbon that has been added or is present, if it was present in the material used, and any titanium dioxide. The water-soluble constituents can then, optionally after their possible existence has been ascertained by the conventional H₂S separation sequence, be separated from one another in the form of their sulfides, chlorides, phosphates, fluorides or other precipitation compounds and isolated. For instance, manganese and aluminium, if present in the residue, and nickel can be precipitated as sulfides at different pH values, dried and then roasted under air to give the corresponding sulfates. The titanium can be separated off in the insoluble residue in the form of the dioxide.

The sulfates obtained can be reused for production of iron phosphates within the scope of this invention.

### EXAMPLES

Analysis: The analysis for phosphorus compounds, especially POCI, and PCls, is preferably conducted by online IR in the offgas stream. For this purpose, the gas stream from the reactor is passed through a glass cuvette that permits the passage of IR radiation within a maximum spectral range, for example through the use of windows made of a thallium compound. By prior calibration (total evaporation of known mass flows of PCl₃ or POCl₃ into a nitrogen gas stream having a known volume flow rate and quantification of characteristic bands in the IR spectrum), it is possible to ascertain the proportion by mass of the phosphorus compounds in the offgas stream.

Stated percentages by weight of the different elements were ascertained by ICP-OES measurements. For this purpose, a weighed amount of the solid-state material is first dissolved in a known amount of an acid, the concentration of the specified elements is ascertained against a calibration measurement in an ICP, and the content of the element in the solid-state material is determined by reverse calculation therefrom.

### Example

120 g of lithium iron phosphate is stirred with 1 litre of 1 molar acetic acid and 250 g of 30% H₂O₂ at room temperature for 30 minutes. Then the precipitate is filtered off with suction, washed three times with water and dried.

55 g of the iron phosphate-containing material produced above (with the following analysis data: Fe 36% by weight, P 21% by weight, Li <1% by weight) is intimately dry-mixed with 6.6 g of finely ground carbon (activated carbon). The water content is <1% by weight.

The powder mixture is heated to 600° C. in the nitrogen stream in a quartz dish in a heated tubular reactor (made of quartz glass, diameter 120 mm). Then the stream is switched to a chlorine gas stream of 100 ml/min. This temperature is maintained for 6 h. From a reaction time of about 10 minutes, two absorption bands at 593 cm⁻¹ and at 1322 cm⁻¹ appear in the IR spectrum of the gas phase, both of which can be assigned to POCl₃.

The iron chloride obtained is separated out in an area cooled to 100° C. together with portions of the POCl₃ formed from the offgas stream and then they are collected together and reacted with sulfuric acid to give iron sulfate and phosphoryl chloride. The mixture is distilled.

The iron sulfate obtained can be used for production of new iron phosphate or LFP/LFMP.

The distillate obtained, consisting of POCl₃, can be used for chemical processes, for example for production of phosphoric esters. It is likewise possible to use the POCl₃ for production of polyphosphoric acid or phosphoric acid. Depending on the method, these are possible feedstocks for production of LFP or LFMP.

Remaining in the dish is a residue of unconverted iron phosphate and excess carbon (22 g altogether).

1. A method of obtaining phosphorus compounds and iron compounds from iron phosphate-containing materials, comprising
i) reacting an iron phosphate-containing material in the presence of a carbon source with chlorine gas at a temperature of 300 to 900° C.,
ii) leading off in an offgas stream the chlorine-phosphorus compounds formed, especially phosphorus oxychloride and any phosphorus trichloride, and iron chloride, and
iii) separating the iron chloride and
iv) the chlorine-phosphorus compounds from the offgas stream.

2. The method according to claim 1, wherein the iron chloride is separated out of the offgas stream in step iii) by resublimation.

3. The method according to claim 1, wherein the iron chloride separated in step iii) is reacted with sulfuric acid, with release and then optionally condensation of any chlorine-phosphorus compounds present.

4. The method according to claim 1, wherein the chlorine-phosphorus compounds, especially phosphorus oxychloride and any phosphorus trichloride, are separated out of the offgas stream by condensation.

5. The method according to claim 1, wherein the iron phosphate consists to an extent of at least 97% by weight, of the elements iron, phosphorus, manganese, aluminium, nickel, titanium and oxygen.

6. The method according to claim 1, wherein the iron phosphate is at least one selected from the group consisting of iron(III) phosphate FePO₄, iron(II) phosphate, especially FePO₄·2H₂O, especially Fe₃(PO₄)₂·8H₂O, and iron(III) pyrophosphate, especially Fe₄(P₂O₇)₃, and compounds of the general formula FeₓMe_{y}PO₄ where Me means manganese, aluminium, nickel and titanium, especially manganese, and x is between 0<x≤3 and y is between 0≤y<2.5.

7. The method according to claim 1, wherein the iron phosphate-containing material used is a material containing a proportion of 5% to 100% by weight, of iron phosphate.

8. The method according to claim 1, wherein the iron phosphate-containing material used is a material containing a proportion of 5% to 100% by weight, of at least one iron phosphate from the group consisting of iron(III) phosphate FePO₄, iron(II) phosphate, especially FePO₄·2H₂O, especially Fe₃(PO₄)₂·8H₂O and iron(III) pyrophosphate, especially Fe₄(P₂O₇)₃.

9. The method according to claim 1, wherein the iron phosphate-containing material used is a material containing
0% to 35% by weight of Mn, calculated as elemental manganese,
0% to 35% by weight of Al, calculated as elemental aluminium,
0% to 35% by weight of Ni, calculated as elemental nickel,
0% to 35% by weight of Ti, calculated as elemental titanium,
0% to 55% by weight, of carbon.

10. The method according to claim 1, wherein the iron phosphate-containing material used is a material containing less than 1% by weight of Li, calculated as elemental lithium.

11. The method according to claim 1, wherein the carbon source is selected from the group of graphite, soot, charcoal, coke, activated carbon, carbon monoxide, oils, methane, polyethylene glycol, biowastes, and sewage sludge.

12. The method according to claim 1, wherein the iron phosphate-containing material contains 1% to 55% by weight, of carbon, especially graphite and/or activated carbon and/or soot.

13. The method according to claim 1, wherein the iron phosphate-containing material has a molar carbon-to-phosphorus ratio of not less than 1.5.

14. The method according to claim 1, wherein the offgas stream led off in step ii) contains phosphorus oxychloride and phosphorus trichloride, in a weight ratio of 10:1 to 1:10.

15. The method according to claim 1, wherein the iron chloride is separated out in step iii) at a temperature of not more than 300° C.

16. The method according to claim 1, wherein the iron phosphate consists to an extent of at least 95% by weight, of the elements iron, phosphorus, manganese, aluminium, nickel, titanium and oxygen.

17. The method according to claim 1, wherein the iron phosphate-containing material used is a material containing a proportion of 40% to 99% by weight, of iron phosphate.

18. The method according to claim 1, wherein the iron phosphate-containing material used is a material containing a proportion of 40% to 99% by weight, of at least one iron phosphate from the group consisting of iron(III) phosphate FePO₄, iron(II) phosphate, especially FePO₄·2H₂O, especially Fe₃(PO₄)₂·8H₂O and iron(III) pyrophosphate, especially Fe₄(P₂O₇)₃.

19. The method according to claim 1, wherein the iron phosphate-containing material used is a material containing
0% to 35% by weight of Mn, calculated as elemental manganese,
0% to 35% by weight of Al, calculated as elemental aluminium,
0% to 35% by weight of Ni, calculated as elemental nickel,
0% to 35% by weight of Ti, calculated as elemental titanium,
0% to 40% by weight, of carbon.
